(19) United States
(12) Patent Application Publication
(10) Pub. No.: US 2008/0234883 A1
(43) Pub. Date: Sep. 25, 2008

(54) METHOD OF GENERATING INSTRUCTION VALUES FOR SERVO-CONTROLLING A FLIGHT PARAMETER P OF AN AIRCRAFT EQUIPPED WITH AN AUTOMATIC PILOT

(75) Inventors: Loic Charles, Toulouse (FR); Denis Hennion, Westmount (CA)

Correspondence Address: LOWE HAUPTMAN & BERNER, LLP, 1700 DIAGONAL ROAD, SUITE 300, ALEXANDRIA, VA, 22314, US

(73) Assignee: THALES, NEUILLY SUR SEINE (FR)

(21) Appl. No.: 12/053,173

(22) Filed: Mar. 21, 2008

(30) Foreign Application Priority Data
Mar. 23, 2007 (FR) 07 02144

(51) Int. Cl. G05D 3/00

(52) U.S. Cl. 701/11

(57) ABSTRACT

The present invention relates to a method of generating instruction values for servo-controlling a flight parameter P of an aircraft equipped with an automatic pilot, between a current value C and a target value T.

It comprises a phase for determining increasing or decreasing instruction values P_{C} of the flight parameter P and instruction values

$${( \frac{d P}{d t} )}_{C}$$

of its time derivative and/or (∫Pdt)_{C} of its integral. It also comprises a phase of use, by a servo-control law of the parameter P of the automatic pilot, of each of the instruction values P_{C},

$${( \frac{d P}{d t} )}_{C}$$

and/or (∫Pdt)_{C}. It also comprises a phase of use, by the automatic pilot, of the value T as final target value. The instruction values P_{C},

$${( \frac{d P}{d t} )}_{C}$$

and/or (∫Pdt)_{C} are calculated from the current value C, the target value T of the parameter P and a time constant τ.

### RELATED APPLICATIONS

The present application is based on, and claims priority from, French Application Number 07 02144, filed Mar. 23, 2007, the disclosure of which is hereby incorporated by reference herein in its entirety.

### FIELD OF THE INVENTION

The present invention relates to a method of generating instruction values for servo-controlling a flight parameter P of an aircraft equipped with an automatic pilot. It applies, for example, to the avionics domain.

### BACKGROUND OF THE INVENTION

An automatic piloting system makes it possible to replace the pilot on board an aircraft. Hereinafter, such a system will be called “automatic pilot”.

Firstly, an automatic pilot needs to constantly ensure the stability of the aircraft about its center of gravity, that is, maintain the aircraft in a controllable attitude by acting on the flight controls. It mainly entails keeping the attitude angles at balance values in the flight domain of the aircraft and ensuring zero values for their mathematical derivatives. For this, a closed servo-control loop principle is applied. The effect of each command sent by the automatic pilot to the flight controls is instantaneously evaluated by sensors which measure the actual values of the attitude angles and their derivatives. These measurements are immediately returned to the automatic pilot. They constitute the loop return and can be used, where appropriate, to adjust the control. Because of its short-term operation, with the stabilization about the center of gravity requiring a rapid loop return, the loop concerned is commonly designated “small loop”.

Secondly, and in the medium term, an automatic pilot needs to ensure that the flight parameters characteristic of a path are followed, which enables it, for example, to acquire and then hold an altitude instruction entered by the pilot. For this, too, the closed servo-control loop principle detailed previously is exploited, again with a return loop provided by sensors. Because of its medium-term operation and the attitude instructions that it addresses to the “small loop”, the loop concerned is commonly designated “large loop”.

One of the technical problems posed by any servo-control loop stems from the conflict between the rapidity and the stability with which an automatic pilot can satisfy a new flight instruction. By considering, for example, an instruction to increase altitude to a target altitude, it is difficult for an automatic pilot to raise the vehicle to this target altitude both rapidly, that is minimizing the climbing time, and at the same time in a sufficiently cushioned manner, that is, avoiding exceeding this target altitude.

The usual solutions mainly involve a compromise between rapidity and stability obtained through adjusting the gains of the servo-control loop. Through the structure of the servo-control law, they can also limit the rate of variation of the flight parameter concerned, the effect of which is to limit the overshoot without in any way wiping it out in all cases of use of the servo-control law.

However, in practice, the adjusting without overshoot of the gains of a servo-control law of a flight parameter is extremely difficult to set in all flight cases. Even if satisfactory results can be obtained by such a method, this is often to the detriment of an acceptable response time.

### SUMMARY OF THE INVENTION

The main aim of the invention is to overcome the above-mentioned drawbacks by providing a method that makes it possible to finely adjust the slope of variation of the flight parameters, notably in the vicinity of the instruction values, and to limit the inertia stored up in the vicinity of these values. To this end, the subject of the invention is a method of generating instruction values for servo-controlling a flight parameter P of an aircraft equipped with an automatic pilot between a current value C and a target value T. It comprises notably a phase for determining increasing or decreasing instruction values P_{C} of the flight parameter P and instruction values

$${( \frac{d P}{d t} )}_{C}$$

of its time derivative and/or (∫Pdt)_{c} of its integral. It also comprises a phase of use, by a servo-control law of the parameter P of the automatic pilot, of each of the instruction values P_{C},

$${( \frac{d P}{d t} )}_{C}$$

and/or (∫Pdt)_{c}. It also comprises a phase of use by the automatic pilot of the value T as final target value. The instruction values P_{C},

$${( \frac{d P}{d t} )}_{C}$$

and/or (∫Pdt) are calculated from the current value C and from the target value T of the parameter P and from a time constant τ.

The instruction values can be calculated permanently through an analog implementation or calculated cyclically through a digital implementation.

Advantageously, the instruction values can progressively change from their initial values to their target values with a characteristic time τ.

For example, the flight parameter P can be the altitude or the speed or the ground elevation or the vertical speed of the aircraft.

Other main advantages of the invention are that it makes it possible to limit the bump sensations felt on board, since the current values of the flight parameters are used to initialize the method according to the invention.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWING

The present invention is illustrated by way of example, and not by limitation, in the figures of the accompanying drawings, wherein elements having the same reference numeral designations represent like elements throughout and wherein:

FIG. 1, a block diagram illustration of an exemplary “small loops” and “large loops” servo-control architecture according to the prior art;

FIG. 2, an illustration by means of a graph of an example of the change in altitude of an aircraft towards a target altitude, when this altitude is driven by a “large loop” servo-control law according to the prior art, with a rapid response time and an overshoot;

FIG. 3, an illustration by means of a graph of another example of change in the air speed of an aircraft towards a target air speed, when this speed is controlled by a “large loop” servo-control law according to the prior art, with no overshoot but with an excessively slow response time;

FIG. 4, a block diagram illustrating an exemplary structure of the present invention;

FIG. 5, a block diagram illustrating an exemplary structure of the present invention adapted to an altitude-mode servo-control large loop in acquisition phase;

FIG. 6, a graph illustrating an example of the change in the altitude of an aircraft acquiring a target altitude, when this altitude is controlled by a servo-control “large loop” using the present invention;

FIG. 7, a block diagram illustrating an exemplary structure of the present invention adapted to an air-speed-mode servo-control large loop in acquisition phase;

FIG. 8, a graph illustrating an example of the change in the air speed of an aircraft towards a target air speed, when this speed is controlled by a servo-control “large loop” law using the present invention.

### DETAILED DESCRIPTION OF THE DRAWING

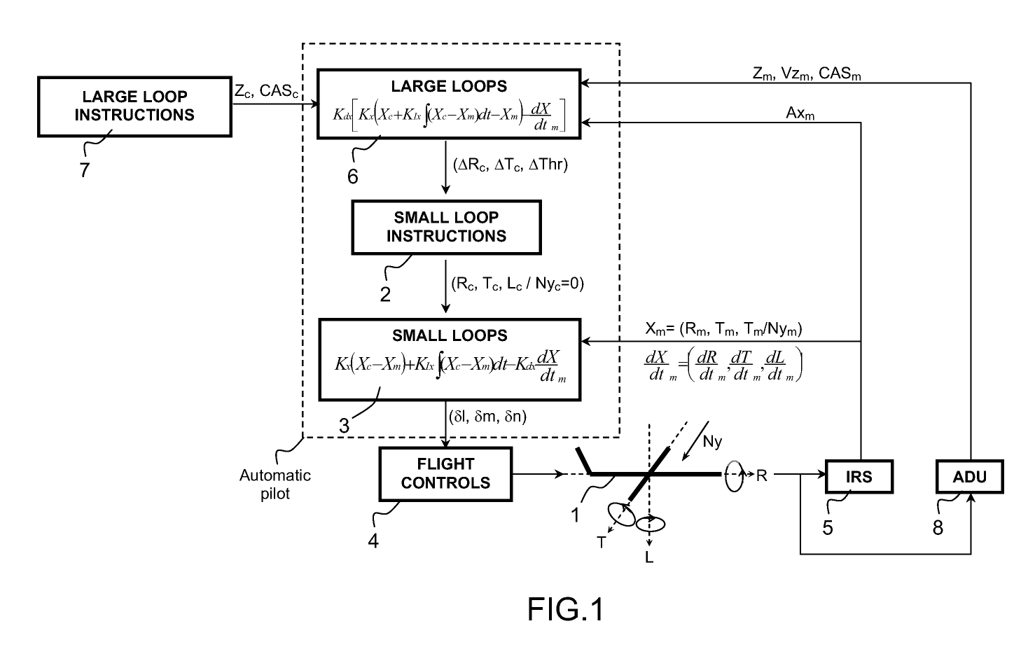

FIG. 1 is a block diagram to illustrate an exemplary servo-control “small loops” and “large loops” architecture, within an automatic pilot, according to the prior art, making it possible to control the attitude and the flight parameters of an aircraft 1. With constant engine or turbine speed, servo-control “small loops” 3 of the automatic pilot of the aircraft 1 seek to control a triplet (T, R, L) of so-called Euler angles fixing the aircraft relative to a terrestrial frame of reference, where T is the pitch angle, R is the roll angle and L is the yaw angle. They can also seek to control the two pitch and roll angles (T, R) and cancel the slip of the aircraft 1 measured through its lateral load factor Ny. To obtain one or other of these types of control, they receive from a module 2 of the automatic pilot a triplet (T_{c}, R_{c}, L_{c}) or a couplet (T_{c}, R_{c}) of instruction angle values. The triplet (T_{c}, R_{c}, L_{c}) or the couplet (T_{c}, R_{c}) can originate from instructions generated by a module 6 representing the servo-control “large loops” or even from attitude instructions selected by the pilot. Also, inertial sensors, usually one or more inertial units 5, commonly designated by the acronyms IRS or AHRS, standing respectively for “Inertial Reference System” and “Attitude and Heading Reference System”, measure the real values Tₘ, Rₘ and Lₘ taken respectively by the three Euler angles and their rates of variation

$$\frac{d T}{d {t}_{m}} , \frac{d R}{d {t}_{m}} and \frac{d L}{d {t}_{m}}$$

and the lateral load factor Nyₘ. The measurements of the attitude angles (Tₘ, Rₘ, Lₘ), of their rate of variation

$$( \frac{d T}{d {t}_{m}} , \frac{d R}{d {t}_{m}} , \frac{d L}{d {t}_{m}} )$$

and of the lateral load factor Nyₘ are addressed to the servo-control “small loops” 3 of the automatic pilot. The instructions (δl, δm, δn) generated by the servo-control “small loops” 3 conventionally follow a correcting structure of proportional integral derivative (PID) type, namely in the form

$$“ - {K}_{dx} \frac{d X}{d {t}_{m}} + {K}_{x} ( {X}_{c} - {X}_{m} ) + {K}_{Ix} \int ( {X}_{c} - {X}_{m} ) d t ” ,$$

X designating the servo-controlled attitude angle, the index “m” the measured value, the index “c” the instruction value and Kₓ (respectively Kₗₓ, K_{dx}) the gain associated with the proportional (respectively integral, derivative) term. These instructions (δl, δm, δn) obtained from the servo-control “small loops” 3, which can be the same as actuator displacement instructions or aerodynamic control surface deflection instructions, are then addressed to a module 4 of the flight controls which can be mechanical (consisting of mechanical actuators, then mechanical linkages then hydraulic actuators) or electrical (consisting of electrical wiring and electro-hydraulic actuators). This module 4 makes it possible in particular to control the aerodynamic elevators, ailerons and rudder of the aircraft 1. By acting on these three types of control surfaces, the flight control module 4 respectively modifies the rates of the pitch T, roll R and yaw L angles of the aircraft 1, in order to achieve the instruction values (T_{c}, R_{c} and L_{c}) or (T_{c}, R_{c} and Ny_{c}=0) which are target values to be achieved for the servo-control small loops 3 of the automatic pilot.

Around the servo-control small loops 3 there are the servo-control “large loops” 6 of the automatic pilot, which justifies their name. These servo-control “large loops” 6 are responsible for controlling the path parameters of the aircraft 1. They receive from a module 7 an instruction value of a path parameter such as an altitude Alt_{c} or an air speed CAS_{c} (designated CAS for Calibrated Air Speed). This module 7 can be a panel for selecting path parameter instructions by which a pilot can address a instruction value for a path parameter to the automatic pilot. This module 7 can even be a flight management system which addresses to the automatic pilot one or more path parameter instructions according to the paths calculated by the flight management system. The servo-control “large loops” 6 also receive measurements of the servo-controlled path parameter and its rate of variation from a sensor 8. Thus, in the case of an altitude-mode servo-control “large loop” 6, an anemo-barometric unit, commonly designated ADU for Air Data Unit, supplies barometric altitude measurements Altₘ and vertical speed measurements Vzₘ. In the case of an air-speed-mode servo-control “large loop” 6, an anemo-barometric unit of ADU type supplies a measurement of the air speed CASₘ and an inertial sensor of IRS or AHRS type supplies a measurement of the inertial longitudinal acceleration denoted AIXₘ. The correcting structures used in the servo-control “large loops” are normally of proportional derivative (PD) or proportional integral derivative (PID) type. The presence or otherwise of an integral term for ensuring the accuracy of the servo-control but to the detriment of stability and rapidity of the latter, depends on the performance levels required. To limit the impact on stability, this integral term is primarily used in an instruction holding phase rather than in a transitional instruction acquisition phase. These correcting structures are generally written in the form

$${K}_{dx} [ {K}_{x} ( {X}_{c} - {X}_{m} ) - \frac{d X}{d {t}_{m}} ]$$

for a PD type corrector and

$${K}_{dx} [ {K}_{x} ( {X}_{c} + {K}_{Ix} \int ( {X}_{c} - {X}_{m} ) d t - {X}_{m} ) - \frac{d X}{d {t}_{m}} ]$$

for a PID type corrector, X here denoting the servo-controlled path parameter, the index “m” the measured value, the index “c” the instruction value and Kₓ (respectively Kₗₓ, K_{dx}) the gain associated with the proportional (respectively integral, derivative) term. Placing the PD or PID type correctors in this form thus renders the term “Kₓ(X_{c}−Xₘ)” or “Kₓ(X_{c}+Kₗₓ∫(X_{c}−Xₘ)dt−Xₘ)” consistent with a variation rate instruction

$$“ \frac{d X}{d {t}_{c}} ” ,$$

which, by adding a limiter to this term, makes it possible to control and limit the rate of variation of the path parameter

$$\frac{d X}{d {t}_{m}}$$

and so limit the overshoots on acquiring the instruction of the path parameter X_{c}. Thus, an altitude-mode servo-control “large loop” 6 often uses a PID type corrector with an active integral term in the altitude holding phase and with a limiter to limit the maximum vertical speed. Xₘ (respectively X_{c},

$$\frac{d X}{d {t}_{m}}$$

) then designates the measured altitude Altₘ (respectively the instruction altitude Alt_{c}, the measured vertical speed Vzₘ). An air-speed-mode servo-control “large loop” 6 often uses a PD type corrector where Xₘ (respectively X_{c},

$$\frac{d X}{d {t}_{m}}$$

) designates the measured air speed CASₘ (respectively the instruction air speed CAS_{c}, the measured longitudinal acceleration AIXₘ). The servo-control “large loops” 6 address to one of the servo-control small loops 3—depending on the type of path parameter servo-controlled—an attitude variation instruction ΔT_{c} or ΔR_{c} which is added to the current attitude instruction T_{c} or R_{c}. A servo-control “large loop” 6 of an automatic pilot can also address an engine speed variation instruction in the case where the aircraft 1 is an airplane equipped with an auto-throttle system servo-controlling its engines or even a collective stick variation in the case where the aircraft 1 is a helicopter provided with a collective axis piloting system. Thus, an altitude-mode servo-control “large loop” 6 can address a trim variation instruction to a trim-mode servo-control “small loop” 3 for an automatic pilot of an airplane and a collective stick variation instruction for a helicopter automatic pilot. An air-speed-mode servo-control “large loop” 6 can address a trim variation instruction to a trim-mode servo-control “small loop” 3 for a helicopter automatic pilot and an engine speed variation instruction for an automatic pilot of an airplane provided with an auto-throttle system. Within the automatic pilot, for the instructions sent by the servo-control “large loops” 6 to the servo-control “small loops” 3 to be able to be effectively followed by the “small loops”, it is necessary for the characteristic dynamic ranges of the servo-control “large loops” 6 to be much slower than those characteristic of the servo-control “small loops” 3.

The servo-control “small loops” and “large loops” architecture of an automatic pilot of the aircraft 1 can be implemented through an onboard computer using an analog or digital embodiment. In the case of a digital embodiment, the different gains of the servo-control “small loops” 3 and “large loops” 6 can be programmed in software so as to depend on the flight parameters such as air speed, or even weight or center of gravity when the latter can be measured. The settings of these gains through simulations involving modelings of the aircraft 1 and through in-flight test campaigns, condition the performance levels of the servo-control “small loops” 3 and “large loops” 6, notably stability, damping, rapidity/response time, static accuracy and overshoot in capture mode.

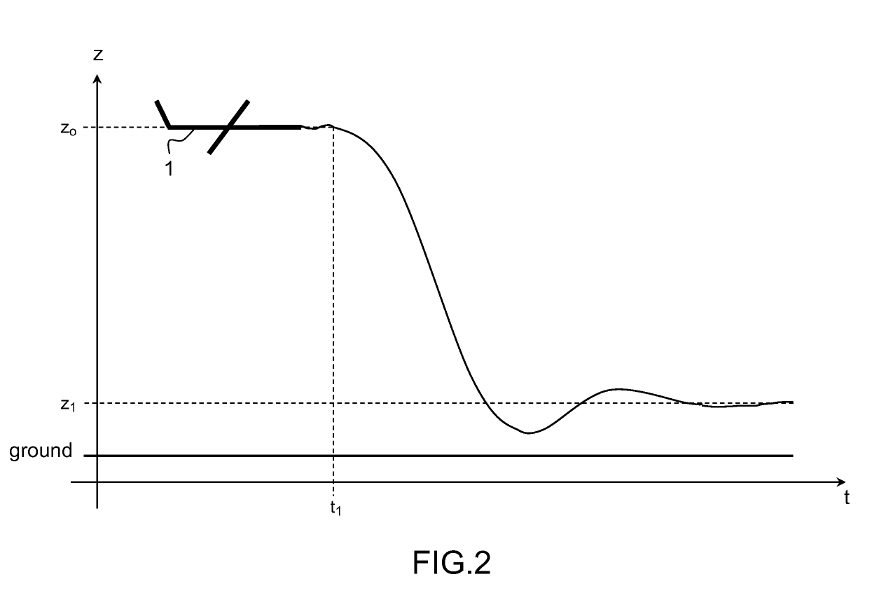

FIG. 2 illustrates, in a system of axes where the X axis represents the time t and the Y axis represents an altitude z, an example of change as a function of time in the altitude z of the aircraft 1, when this altitude is controlled by an automatic pilot with an altitude-mode servo-control large loop with no vertical speed limiting term according to the prior art as presented in FIG. 1.

The aircraft 1 flies at an altitude Z₀ at an initial instant t₀=0 with the engaged automatic pilot invoking an altitude-mode large loop servo-control holding the instruction Z_{c}=Z₀. Then, at the instant t₁, the pilot decides to descend to acquire a new target altitude Z₁<Z₀ and uses the instruction selection panel to modify the value of the instruction, or Z_{c}=Z₁. At the level of the altitude-mode servo-control large loop then operating in acquisition phase, an altitude difference “Z_{c}−Zₘ=Z₁−Z₀” is created which induces, for example in the case of an airplane, a nose-down attitude variation instruction to the trim-mode servo-control small loop which then acts on the flight controls which in turn act on the elevator so as to cause the aircraft to pitch down and descend to try to take up the difference “Z_{c}−Zₘ”. If the setting of the gains of the servo-control large loop favors the response time and the rapidity of the law, that is, of the gains K_{z} and K_{dz} with high values, the term of the servo-control large loop equivalent to a vertical speed instruction

$$“ {Vz}_{c} = \frac{d Z}{d {t}_{c}} ”$$

takes high values, notably initially, but also when the altitude Zₘ of the aircraft is close to its instruction Z_{c}=Z₁. This causes an overshoot to be generated that is all the greater as the gain values increase and the aircraft is able to follow the instruction vertical speed. The other effect induced by these high gain values is a reduction in the damping of the servo-control large loop which is reflected in oscillations that are all the less well damped about the altitude instruction Z_{c}=Z₁ as shown in FIG. 2. The presence of a limitation on the term of the servo-control large loop equivalent to this vertical speed instruction

$$“ {Vz}_{c} = \frac{d Z}{d {t}_{c}} ”$$

makes it possible to limit the value of this vertical speed instruction and thus can make it possible to reduce the overshoot of the altitude instruction Z_{c}. However, an overshoot can prove critical when the lower instruction altitude Z_{c}=Z₁ corresponds to a minimum ground elevation under which it is forbidden to descend for fear of striking the ground.

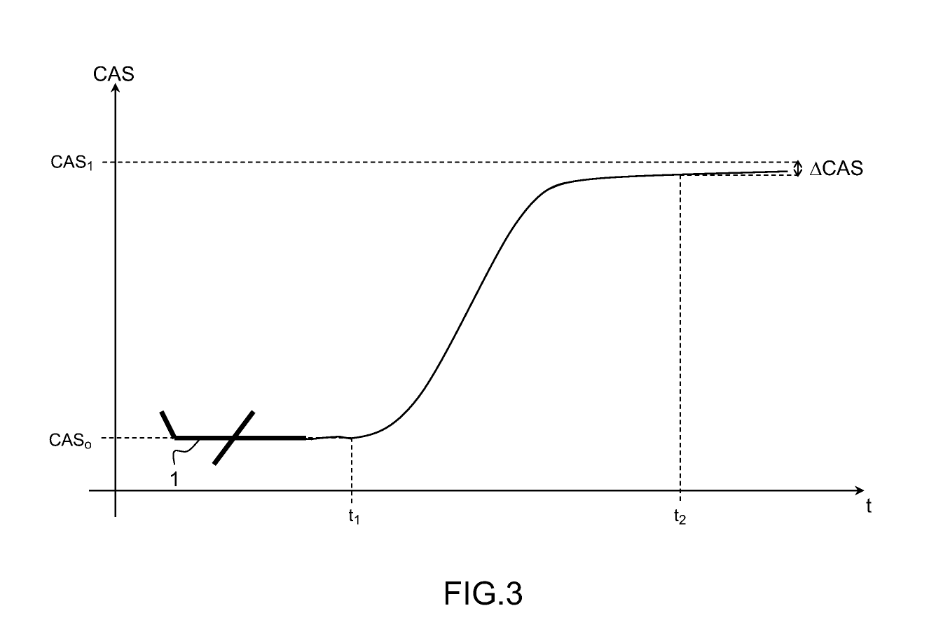

FIG. 3 illustrates, in a system of axes where the X axis represents the time t and the Y axis represents an air speed CAS, an example of the trend as a function of time of the air speed CAS of the aircraft 1, when this air speed is controlled by an automatic pilot with a speed-mode servo-control large loop according to the prior art as presented in FIG. 1. The aircraft 1 flies at an air speed CAS₀ at an initial instant t₀=0 with the engaged automatic pilot invoking an air-speed-mode servo-control large loop holding the instruction CAS_{c}=CAS₀. Then, at an instant t₁, the pilot decides to accelerate to a new target air speed CAS₁>CAS₀ and uses the instruction selection panel to modify the value of the instruction, or CAS_{c}=CAS₁. An air speed difference “CAS_{c}−CASₘ=CAS₁−CAS₀” is created which induces, for example in the case of a helicopter, a nose-down trim variation instruction on exiting the speed-mode servo-control large loop, towards the trim-mode servo-control small loop which then acts on the flight controls which in turn act longitudinally on the swashplate of the helicopter so as to make it pitch down and accelerate to take up the difference “CAS_{c}−CASₘ,”. If the setting of the gains of the servo-control large loop favors a good damping and non-overshooting of the final instruction CAS_{c}, that is, of the gains K_{CAS} and K_{Ax} with low values, the term of the servo-control large loop equivalent to a longitudinal acceleration instruction

$$“ {AX}_{c} \approx \frac{d CAS}{d {t}_{c}} ”$$

takes low values notably when the air speed CASₘ of the aircraft is no longer very far from its instruction CAS_{c}=CAS₁. This is reflected in a time t₂ to reach the final instruction that is relatively long as presented in FIG. 3, where t₂ is characterized by the crossing of a threshold ΔCAS defined about the final instruction CAS₁.

The aim of the present invention is to supply progressive instructions to the various terms that make up a servo-control large loop in acquisition phase so as to reach the final target instruction with no overshoot.

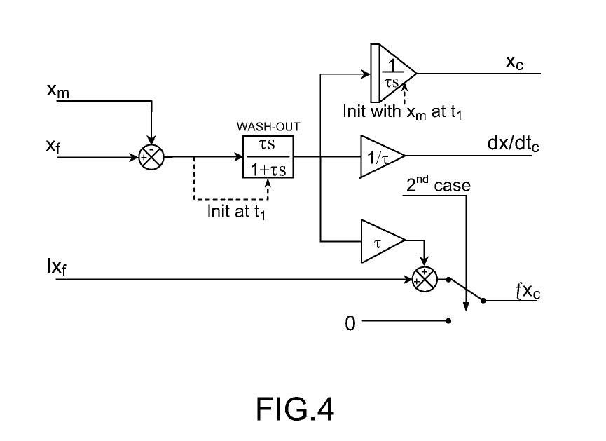

FIG. 4 is a block diagram illustrating an exemplary structure of the present invention suited to a servo-control “large loop” for a path parameter X, used in acquisition phase for a non-zero final instruction X_{f}, or even for a certain final instruction IX_{f} of ∫Xdt and a final zero instruction X_{f}. In the first case, the present invention permanently monitors the measurements

$$( {X}_{m} , \frac{d X}{d {t}_{m}} )$$

of the parameter X and its rate of variation. In the second case, it permanently monitors the measurements (Xₘ, ∫Xdtₘ) of the parameter X and of the parameter associated with its integral. The characteristic time of the present invention is called τ. The delay τ is chosen so as to be compatible with the dynamic range of the servo-control large loop concerned. In the first case (respectively second case), when in capture phase for the final instruction X_{f} (respectively for the final instructions IX_{f} and X_{f}=0), the relation (1):

$$\begin{matrix}\vert {X}_{f} - {X}_{m} \vert \leq \vert τ \times \frac{d X}{d {t}_{m}} \vert & ( 1 ) \\ respectively \text{:} & \\ \vert {IX}_{f} - {\int }_{ }^{ } X d {t}_{m} \vert \leq \vert τ \times {X}_{m} \vert & ( 1 )\end{matrix}$$

permanently evaluated by the present invention becomes true, the “wash-out” filter is initialized with the value “X_{f}−Xₘ”. This filter then progressively erases this initialization value. This erased value is used as input for a gain integrator “1/τ” and initialized when the condition (1) becomes true at the value Xₘ. The output of this integrator can be used to generate an instruction X_{c} which changes progressively from the value Xₘ on initialization to the final instruction X_{f}. In parallel, in both cases considered, the output of the “wash-out” filter is multiplied by a gain “1/τ” to generate an instruction

$$\frac{d X}{d {t}_{c}}$$

which changes progressively from the value

$$“ \frac{( {X}_{m} - {X}_{f} )}{τ} ”$$

to a zero value. In parallel, in the second case only, the output of the “wash-out” filter is multiplied by a gain “τ” and aggregated with the final instruction value IX_{f} to generate an instruction ∫Xdt_{c} which changes progressively from the value “IX_{f}+τ(X_{f}−Xₘ)” to the final value IX_{f}.

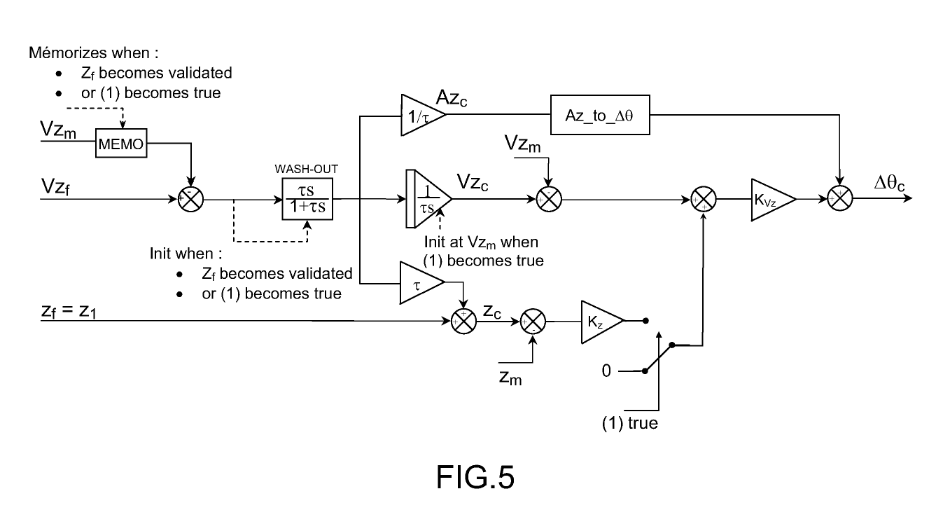

FIG. 5 is a block diagram to illustrate an exemplary adaptation of the present invention to the proportional derivative structure of an altitude-mode large loop in acquisition phase. Initially, the large loop itself is reduced to a simple vertical speed mode proportional term: the flight parameter X is then formally identified with a vertical speed Vz. No type (1) condition is used and the present invention is used for a first time immediately the new final altitude instruction Z_{c}=Z₁ is validated. An instruction vertical speed Vz_{f} (equivalent to an instruction X_{f} and to the maximum vertical speed of a limiter for an altitude-mode large loop structure according to the prior art), from which is subtracted the measured and stored current vertical speed value Vzₘ, is used as input for the “wash-out” filter. The present invention then generates two changing instructions Vz_{c} and

$$\frac{d Vz}{d {t}_{c}} = {Az}_{c}$$

corresponding to an instruction vertical acceleration. This changing vertical acceleration instruction after conversion to a trim variation instruction is then aggregated with the trim variation instruction issued by the servo-control large loop, as input for the trim-mode servo-control small loop. In parallel, the type (1) condition “|Z₁−Zₘ|≦|τ×Vzₘ|”—equivalent to |IX_{f}−∫Xdtₘ|≦|τ×Xₘ| since ∫Vzdtₘ=Zₘ—is permanently evaluated. When the condition (1) becomes satisfied, the present invention is implemented a second time. A new instruction vertical speed Vz_{f}=0, from which is subtracted the current measured and stored vertical speed value Vzₘ, is used as input for the “wash-out” filter. The present invention then generates three changing instructions: Vz_{c} which tends progressively towards 0,

$$\frac{d Vz}{d {t}_{c}} = {Az}_{c}$$

which tends, a progressively, towards 0 and ∫Vzdt_{c}=Z_{c} which progressively tends towards Ix_{f}=Z₁. At the same time, when the condition (1) becomes satisfied, the hitherto vertical-speed-mode V_{z} servo-control large loop becomes an altitude-mode servo-control large loop since it receives, in addition to the vertical speed term, an altitude term. This altitude-mode servo-control large loop is servo-controlled by the two changing instructions Vz_{c} and Z_{c} which will make it possible to progressively bring the aircraft 1 to its final instruction Z₁ with no overshoot; the effectiveness of the trim variation instruction obtained from the altitude-mode large loop being reinforced by the additional trim variation instruction obtained from the vertical-acceleration-mode instruction Az_{c}.

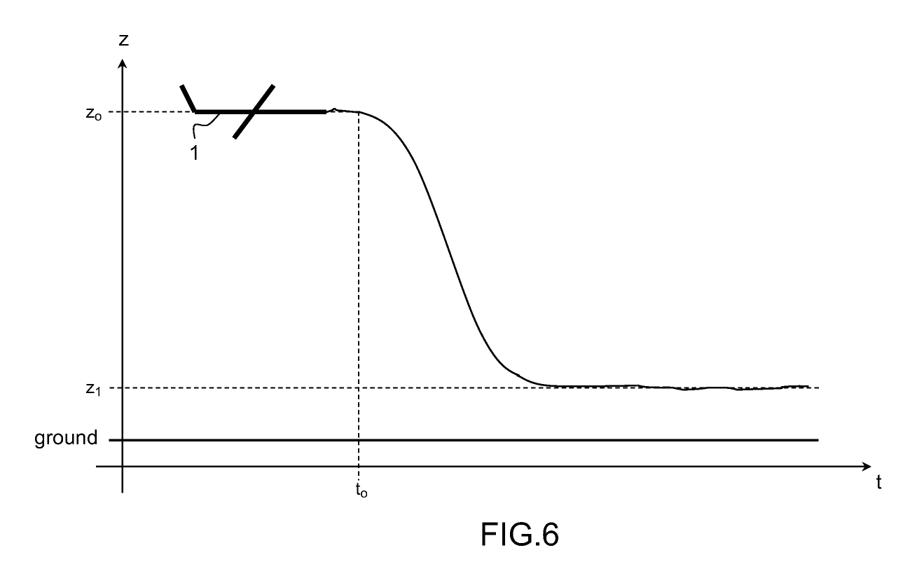

FIG. 6 illustrates, in the same axis system as FIG. 2, an example of trend over time of the altitude Zₘ of the aircraft 1 when the altitude-mode servo-control large loop of its automatic pilot is provided with the altitude acquisition phase of the present invention. The aircraft 1 flies at an altitude Z₀ at an initial instant t₀=0 with the engaged automatic pilot invoking an altitude-mode servo-control large loop in holding phase at the instruction Z_{c}=Z₀. At the instant t₁, the pilot decides to descend to acquire a new target altitude Z₁<Z₀ and uses the instruction selection panel to modify the value of the instruction, or Z_{c}=Z₁. The altitude-mode servo-control large loop then changes to acquisition phase according to the invention. Initially, the vertical speed Vzₘ of the aircraft 1 progressively converges towards a predefined instruction vertical speed Vz_{f} by following the changing instruction Vz_{c} obtained from the present invention to which it is servo-controlled, the altitude Zₘ of the aircraft 1 then changes according to a leveling-off technique. Then, the vertical speed being stabilized at Vz_{f}, the altitude Zₘ of the aircraft 1 changes linearly with time. In parallel and from the start of the acquisition phase for the final altitude Z_{c}=Z₁, the condition “|Z₁−Zₘ|≦|τ×Vzₘ|” is evaluated permanently, that is, evaluated cyclically for a digital computer and continually for an analog computer. Immediately this condition becomes true at the instant t₂, the present invention generates two new changing instructions, a vertical speed instruction Vz_{c} which changes progressively from the value Vzₘ measured at the instant t₂ to a zero value and an altitude instruction Zc consistent with the instruction Vz_{c} and which changes progressively from the value Zₘ measured at the instant t₂ to the final altitude value Z_{c}=Z₁. The aircraft 1 servo-controlled on these two changing instructions (Vz_{c}, Z_{c}) then sees its altitude follow a leveling-off path to reach the final altitude Z₁ without overshooting it.

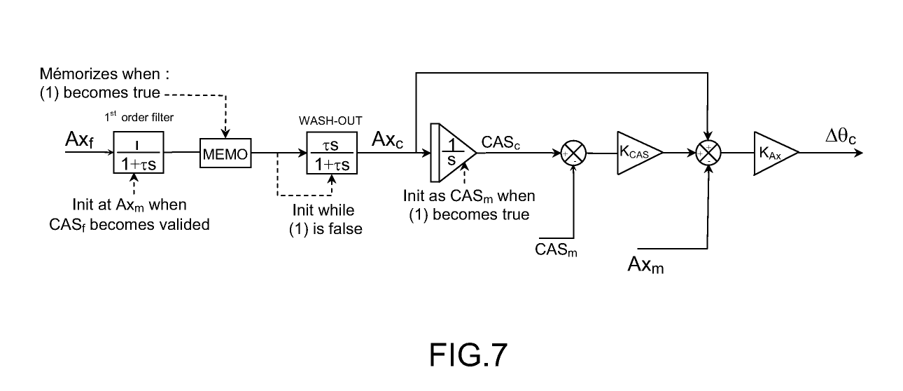

FIG. 7 is a block diagram to illustrate an exemplary adaptation of the present invention to the proportional derivative structure of an air-speed-mode large loop (CAS) in acquisition phase. Let CAS0 be the measured value of the air speed CASₘ on inserting a new air speed instruction CAS1. When CAS1 is inserted, initially, an instruction longitudinal acceleration Ax_{c} is generated by means of a first order filter of time constant τ, initialized with the current value Axₘ of the longitudinal acceleration of the aircraft 1 and with an instruction reference longitudinal acceleration Ax_{f}, the sign of the reference longitudinal acceleration Ax_{f} being identical to the sign of the difference “CAS1−CAS0”. The “wash-out” filter does not operate, it is transparent and remains to be initialized with the current value of the output of the first order filter. A unitary gain integrator, initialized on insertion of the new instruction CAS1 with the current value of the air speed CAS0, then integrates the output of the “wash-out” filter, that is, the instruction longitudinal acceleration Ax_{c} to generate a speed instruction CAS_{c}. In parallel, the condition |CAS₁−Xₘ|≦|τ×Axₘ| is permanently evaluated. Secondly, immediately it becomes true, the output of the first order filter is memorized at its current value and is progressively erased by the “wash-out” filter which becomes active. Thus, the changing longitudinal acceleration instruction Ax_{c} then tends progressively towards 0 and at the same time, the speed instruction CAS_{c} tends progressively towards the final instruction value CAS1. The two changing instructions (Ax_{c}, CAS_{c}) are then used as instruction for the proportional derivative structure of the air-speed-mode large loop: they make it possible to gradually bring the aircraft from its initial air speed CAS0 to its final value CAS1 without overshooting the latter.

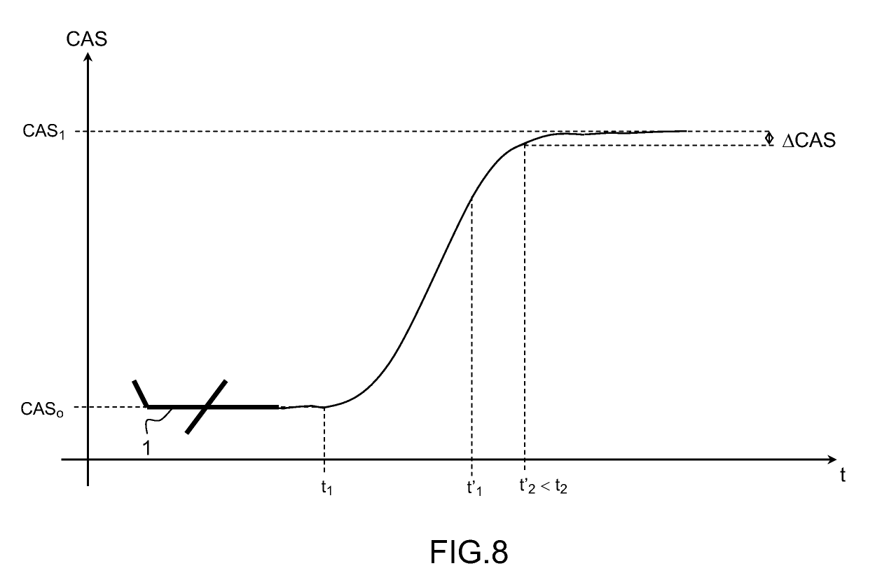

This is illustrated through FIG. 8 which represents, in the same system of axes as that of FIG. 3, the changing air speed of the aircraft 1, equipped with an automatic pilot with a speed-mode servo-control large loop using the present invention, on acquiring a new instruction CAS1 greater than the initial speed CAS0. Initially, a leveling off at speed is performed so as to tend towards a linear change in the air speed CASₘ with time, that is, at constant acceleration. Secondly, from the instant t′₁, a second leveling-off at speed enables the aircraft 1 to tend towards a zero acceleration and the instruction final speed CAS1 which is reached at an instant t′₂. Compared to the example presented with FIG. 3, thanks to the present invention, the gains of the speed-mode servo-control large loop were able to be increased, which made it possible to reduce the time to reach the final instruction CAS1 without overshooting it.

The exemplary embodiments of the invention given previously in the case of the altitude and the air speed can, of course, be applied to other flight parameters and servo-control large loops of the automatic pilot of the aircraft 1, such as, for example, a servo-control loop on a glide beam with a leveling-off at a safety height, this without departing from the principles of the invention.

Another advantage of the invention described previously is that it makes it possible to limit the control bumps observed today on applying a new instruction or on changing instruction, these bumps being due to the sudden and immediate difference created between the current value of the flight parameter and the target value. Moreover, the invention can be implemented in existing automatic piloting systems with a minimum of impact on their hardware and software architecture, into which it integrates perfectly and which it even manages to exploit.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A method of generating instruction values for servo-controlling a flight parameter P of an aircraft equipped with an automatic pilot, between a current value C and a target value T, comprising the steps of:
determining a phase for increasing or decreasing instruction values PC of the flight parameter P and instruction values
$${( \frac{d P}{d t} )}_{C}$$
of its time derivative and/or (∫Pdt)_{C} of its integral;
a phase of use, by a servo-control law of the parameter P of the automatic pilot, of each of the instruction values P_{C},
$${( \frac{d P}{d t} )}_{C}$$
and/or (∫Pdt)_{C};
a phase of use, by the automatic pilot, of the value T as final target value; the instruction values P_{C},
$${( \frac{d P}{d t} )}_{C}$$
and/or (∫Pdt)_{C} being calculated from the current value C and from the target value T of the parameter P and from a time constant τ, wherein the instruction values change progressively from their initial values to their target values with a characteristic time τ.

2. The method as claimed in claim 1, wherein the instruction values are calculated permanently through an analog implementation.

3. The method as claimed in claim 1, wherein the instruction values are calculated cyclically through a digital implementation.

4. The method as claimed in claim 1, wherein the flight parameter P is the altitude or the speed or the ground elevation or the vertical speed of the aircraft.
